(19) United States
(12) Patent Application Publication
(10) Pub. No.: US 2009/0123693 A1
(43) Pub. Date: May 14, 2009

(54) Fiber Reinforced Plastic Composites and Method and Apparatus for Making

(76) Inventor: Kermit D. Paul, Bethlehem, PA (US)

Correspondence Address: CHARLES A. WILKINSON, ESQ., 68 EAST BROAD STREET, P. O. BOX 1426, BETHLEHEM, PA, 18016-1426, US

(21) Appl. No.: 12/261,646

(22) Filed: Oct. 30, 2008

Related U.S. Application Data
(60) Provisional application No. 61/000,987, filed on Oct. 30, 2007.
(60) Provisional application No. 61/001,417, filed on Oct. 30, 2007.

(51) Int. Cl. B32B 5/12; B29C 47/12; B29C 47/00

(52) U.S. Cl. 428/113; 425/461; 425/215; 264/176.1

(57) ABSTRACT

A new product is made by an improved pultrusion method including the use of repetitiously moved cooled consolidation plates by the action of which excess plastic resin is allowed to escape from the sides and wherein the flow of plastic carries and shapes transverse reinforcing fibers to curve along the edge of the product preventing delamination of the product. The repetitiously moved consolidation plates provide a more accurately dimensional product and require less pultrusion drawing force than the usual cup and plunger pultrusion die.

### CROSS-REFERENCE TO RELATED APPLICATIONS

This utility application takes priority from U.S. Provisional Application Ser. No. 61/000,987 entitled, “Improved Compressor Vane—Manufacturing Process” and U.S. Provisional Application Ser. No. 61/001,417 entitled “Improved Compressor Vane”, both filed Oct. 30, 2007 in the name of Kermit D. Paul.

### BACKGROUND OF THE INVENTION

1. Field of the Invention

This invention relates to improved fiber reinforced plastic items and methods of making plus apparatus for making such items. More particularly, the invention is directed to an improved method and apparatus for making fiber reinforced plastic products such as, for example, compressor vanes with improved reinforcing fiber patterns around the edges which reinforcing provides strength and wearability by a continuous process for forming such reinforced article at a very substantially reduced cost.

2. Preliminary Discussion

Fiber reinforced plastic articles have been made for some time with superior strength and durability plus reduced weight as compared to uni-composition materials such as metal and other inherently strong materials. In the making of such fiber reinforced products, mixtures of various filaments and plastic resins are used to produce composites that have unique properties compared to traditional engineering materials such as metals and non-reinforced plastic resin materials. In such composites, the filaments provided in the resin materials may increase the strength of the composites so much that they may far exceed in strength even the strongest metals, even though the composites are considerably lighter than their metal counterparts.

Thermoplastic resins are frequently used to make the plastic and fiber composites because thermoplastics lend themselves to fabrication and working by hot forming processes such as extrusion, forging, stamping and the like and since the longitudinal fibers in a fiber plastic composite provide longitudinal strength enabling a fiber plastic material to be pulled through a die in order to provide cross-sectional shape while forming a long, thin structured member reinforced longitudinally by strength providing fibers. Reinforced thermoplastic composites are, therefore, typically produced by impregnating bundles of filaments with molten resin of whatever thermoplastic material desired. The molten resin wets the filaments, or sticks to the filaments, so that when cooled again the filaments and thermoplastic will be adhered together. Usually the filament bundles will be caused to open up to allow good mingling of the thermoplastic and the longitudinal fibers. Shaping of such materials or material composites is frequently accomplished by pulling the material through a so-called pultrusion die or operation by a capstan of suitable form.

The initial filament reinforced preimpregnated resin composite is commonly referred to as a “prepreg” for “reinforced pre-impregnated resin composite” and is frequently made in a sheet form which may be later formed into individual parts or combined together to form more complicated products or blanks for use in such products. Commercially available prepreg is typically available in variations of three forms (a) resin with unidirectional or UD fiber orientation (b) resin with woven fabric serving as the fiber reinforcement usually at a 0-90 degree fiber orientations and (c) laid up layers of UD, or unidirectional, fibers overlapped to achieve the usually desired 0-90 degree orientations. The plastic resin may have been mixed with the fibers by applications of a slurry of small plastic particulates which is then dried and melted about and among the fibers or may be applied to the fibers initially in molten form. Due to the high viscosity of thermoplastic in the molten state and the tightly twirled threads of woven reinforcement, woven fabric reinforced thermoplastic prepreg is not very common.

The usual prepreg is typically very strong in the direction of the filaments, but is relatively weak or even quite weak transverse to the fibers having a strength in such transverse direction usually no greater than the strength of the matrix thermoplastic or alternatively no greater than the bonding of the thermoplastic to the fibers. In order to provide transverse strength or lateral structural strength to the plastic composite prepreg the expedient has frequently been adopted of making two similar linear prepregs and then severing one linear prepreg into individual short strips only as long as the width of the prepreg and welding or heat bonding the short lengths cross wise to the long strips. Many layers of such composite prepreg can then be passed through a heater to elevate the matrix material above its melting point and passed through a further adhesion process where it is essentially pulled through a drawing die, relying on the longitudinal strength of the principal longitudinal fibers to draw the soft material through the die. In such manner, a composite or part can be made having transverse as well as longitudinal reinforced strength. Alternatively, the prepreg can be used to form more complicated parts principally by laying the composite prepreg sheets into molds or over forms while shaping it by the application of heat to conform the prepreg with the die or the form, with the fibers oriented at angles designed to provide the desired strength and other properties to the particular part which is being formed.

Various arrangements of cross fibers on a main longitudinally reinforced prepreg have been devised to provide various reinforcing patterns. However, as will be recognized, the formation of a cross reinforced prepreg as described is inevitably a labor intensive procedure and the resulting composite prepreg is subject to mistakes of such labor in the angles of attachment of the cross fiber sections which errors or mistakes may lead to serious defects in the final composite prepreg which could in a serious case lead to catastrophic failure of an important molded part.

In an earlier application, the present inventor has described and claimed an improved less labor intensive procedure for forming composite prepregs with multi-layers of fibers at more or less right angles to each other. In such method, using an improved apparatus arrangement, two normal extended prepregs are formed and a third prepreg is formed usually having an enhanced number of longitudinal fibers. The prepreg with the enhanced number of fibers is then cut or chopped into a number of sections, each such section having a uniform length exactly matching the width of the other two prepregs. The two continuous prepregs are then arranged to be passed in close proximity through or past a suitable mechanism which consecutively places or injects the short severed sections from a stack of such sections between the two continuous prepregs, after which the entire assembly is passed into a heating means which effects amalgamation of the plastic of the prepreg sections together into a single multi-component prepreg having a multi-component structure. In other words, individual short severed lengths of prepreg are arranged to be injected or passed into a space between the two longitudinal prepregs passing by an assembler, such that the severed prepregs become wedged between the other prepregs and will be carried away with the moving prepregs and as the plastic material melds together, will be caused to be consolidated with or to the other linear prepregs. Those composite prepregs can then, after a suitable length is produced, be combined with other prepregs to form suitable products. One of such products is the product of the present invention in which suitable lengths of a long strip produced by a novel pultrusion operation are severed to form a part such as a vane for a rotary slipping vane air compressor or a vacuum pump, which vane has improved strength and durability properties in accordance with the present invention, as a result of having an improved pattern of fibers at the edge within the plastic matrix in the final part. Such pattern of reinforcing comprises a molding or curving of the cross or lateral fibers in the final part so they are curved towards the center of the part edge which not only strengthens the edge portions of the vanes, but it has been found, guards against delamination of the layers of plastic derived from the structure of the original prepregs from which it is made by countering any tendency of such layers of plastic to split apart. Thus, by use of the present invention, a molded shape in a fiber reinforced plastic can be formed, which has fiber reinforced lateral edges. The length of the pieces can be varied by severing different lengths of the molded product. As will be presently explained, furthermore, not only does the present inventor's procedure and apparatus provide a new and improved product, but provides such product and other products in an improved, more efficient manner, not heretofore achieved.

A very frequent type of pultrusion die is the so-called piston cup die in which a U-shaped base has a piston inserted into it from one side, usually the top. This arrangement of die is particularly useful for forming prepreg material since it is readily adaptable for forming smooth elongated ribbon-like structures with longitudinal fibers running through them. Occasionally roller dies will be substituted for the more conventional piston and cup die, but tend to be difficult to maintain in proper alignment for uniform product fabrication. In the present invention, instead of using a cup and piston type of die to form a product from prepreg, a new type of pultrusion die, referred to as a reciprocating consolidating plate die, and referred to generally as consolidation plates, is used to form the prepreg package or bundle into the desired final product. By the use of such consolidation plates a series of stacked consolidation prepregs can be molded together and the sides molded together with the cross fibers to form the superior side reinforcing pattern which forms one aspect of the present invention.

The present inventor has unexpectedly discovered therefore that particularly in the manufacture of vanes for large rotary vane compressors and vacuum pumps, but useful also for making other parts from fiber reinforced plastic components, the prepreg material molded by a pultrusion operation to form the blade or other part applied in the final pultrusion operation can be provided with a useful pattern of cross reinforced fibers providing superior edge properties to the blade including greater strength, wear and delamination resistance and economical fabrication hitherto impossible to attain in the usual manufacturing methods.

The present Applicant's improved process as indicated involves the use of a new type of pultrusion die. In order to shape a prepreg into a uniform thickness and width ribbon of plastic containing longitudinal strength imparting fibers, such ribbon or collection of prepregs is customarily passed through a die. Since the material passing through the die has considerable longitudinal strength imparted by the longitudinal fibers passing through it or within it, such material can be pulled by rollers between which it passes or can be pulled in any other convenient way through the die, which is commonly referred to a pultrusion die wherein the material and particularly the longitudinal fiber material is pulled through the die carrying the heated thermoplastic material which has been interspersed into it or among the fibers and which is carried through as part of the entire structure and molded by the walls of the die into the shape of the surface of the die, which is in the desired shape of the final product.

In the present Applicant's last pultrusion step, rather than using a cup and plunger-type die which can be adjusted to form composite ribbons of fiber reinforced plastic of various thickness, or for that matter, a roller die or even a solid pultrusion die, the present inventor instead uses a die structure formed of reciprocating consolidation die plates which as the hot collection of prepregs passes through such plates continuously pat or knead the plastic, forming it into a uniform thickness at the same time, expelling excess thermoplastic towards the side, then forming the edges which typically leaves a thin flashing of excess material which can be easily trimmed off by a suitable ceramic blade. When this step has been completed, it will be found that the cross filaments along the edges of the strip will have been molded into conformance with the flow of the plastic into curved fiber configurations around the edge of the strip which very effectively reinforce the sides of the product, making it very durable. When flashing is removed, the ends of the fibers are left molded into or squeezed together with the curved laminations remaining from the original prepreg material resulting in a very delamination resistant edge upon the vane.

Not only does the use of reciprocating consolidations plates of the invention form a very superior curved reinforcement of the sides of the product by the transverse fibers of the product, but in addition, the use of the reciprocating consolidation plate die design of the invention requires less pulling force by the final end capstan or capstans of the line than the use of the usual cup and plunger dies since the consolidation plates move with the product, but also since less force is required to pull through or past the consolidation plates, a very much lesser degree of wear occurs in the consolidation plates than in the more usual piston/cup type pultruder die. Since the plastic resin in a plunger cup type die is cooled near the walls of the die and thus cooler more resistant plastic is forced directly down along the walls of the die by the plunger, considerable wear tends to quickly appear at the bottom of the die along the wall, quickly resulting in out of shape plastic sections of fiber reinforced plastic drawn through the die, which requires sanding or machining off to meet expectations. No such wear occurs in the consolidation plates of the present invention so no secondary operations to bring to specifications are necessary.

The method, apparatus and products of the present invention are generally applicable to fiber reinforced products made from the standard components from which fiber reinforced products are generally formed by pultrusion processes, namely and by way of example only, graphite, glass and KEVLAR fibers and a variety of resins such as polyphenylene sulfide (PPS), polyetheretherketone (PEEK) or polyetherimide (PEI), but other fibers and resins may be used and such wide adaptability may be considered as one of the advantages of the invention.

### OBJECTS OF THE INVENTION

It is an object of the present invention, therefore, to provide an object formed from fiber reinforced plastic material in which the edges are reinforced by curvatures imparted to the ends of reinforcing fibers by a final molding operation.

It is a still further object of the invention to provide an improved product in the form of rotary compressor vanes having improved edge durability as the result of being finally shaped by a special pultrusion die.

It is a still further object of the invention to provide a pultrusion die formed of reciprocating consolidation plates.

It is a still further object of the invention to provide a pultrusion die formed of reciprocating consolidation plates which are water cooled to prevent adhesion thereto of plastic during use.

It is a still further object of the invention to provide a method of making a fiber reinforced plastic composite product wherein a series of prepregs comprised of longitudinal fiber sections which provide longitudinal tensile strength and transverse fiber containing sections providing lateral strength are combined in a pultrusion die arrangement comprising at least two consolidation plates arranged to provide a forward and backward movement with a compressive action during the forward movement in short overlapping but discontinuous movements coordinated with the movement of fiber reinforced ribbon.

It is a still further object of the invention to provide a method of making a fiber reinforced plastic composite product including consolidating the product by consecutive movable compressions with planar slightly angled consolidation plates.

It is a still further object of the invention to provide a pultrusion die requiring considerably less energy or power for passage of fiber reinforced plastic resin being shaped through such die than is experienced in normal pultrusion with a cup and piston die.

It is a still further object of the invention to provide a pultrusion die apparatus comprising reciprocating consolidation plates in which die wear is practically negligible.

It is a still further object of the invention to provide a pultrusion line requiring less touching up of the product made therein as a result of better retainment of shape as the result of less die wear of the operation.

It is a still further object of the invention to provide a pultrusion operation for making fiber reinforced plastic product having substantially less operating costs than pultrusion programs heretofore available.

Further objects and advantages of the invention will become apparent from a careful review of the attached specifications and drawings.

### SUMMARY OF THE INVENTION

There is described a method and apparatus for making improved fiber reinforced plastic resin products having side edges reinforced by curved fiber sections which substantially prevent delamination of the layers of such plastic resin and fiber along the edges as well as strengthening the product generally. The improved method comprises basically the provision of fiber reinforced plastic resin blanks or prepregs having both longitudinal and transverse reinforcing fibers and passing such prepregs while heated through a pair of reciprocating consolidation plates while continuously forcing such plates against the top and bottom of the composite plastic strip while excess plastic is expelled from between the plates to the side between restricted side openings. The flow of plastic resin from the sides creates a restricted internal flow within the plastic ribbon which moves the lateral reinforcing fibers toward the opening between the plates so that the lateral or 90 degree fibers assume a generally curved conformation on the sides which when the ribbon or strip of fiber reinforced plastic moves beyond the consolidation plates persists in the form of curved reinforcing fibers in the sides of the ribbon which ribbon when severed into shorter strips to form a product such as air compressor blades serves to reinforce the edges and particularly serves as a guard against delamination caused by shocks and the like.

The invention also provides a pultrusion process which can effectively and efficiently make fiber reinforced products of various natures with the use of considerably less power and more closely to specifications by the use of a pultrusion die comprised of reciprocating consolidation plates to effectively consolidate the plastic matrix of the product and reinforcing fibers together by a reciprocating action of the consolidating plates and wherein less energy is used for such consolidation particularly in the form of pulling or capstan force plus less die wear or consolidation plate wear is experienced as a result of the lesser force experienced by the die arrangement.

### BRIEF DESCRIPTION OF THE DRAWINGS

FIG. 1 is a diagrammatic layout of a fabrication line for a pultrusion line designed to fabricate fiber reinforced vanes for a sliding vane air compressor apparatus.

FIG. 2 is a diagrammatic illustration of a conventional piston cup type pultrusion die.

FIG. 3 is a cross section of the main components of a typical sliding vane type air compressor illustrating the movement of the sliding vanes during operation of the compressor.

FIG. 4 is an enlarged diagrammatic view of the intersection of the ends of a typical new compressor vane with the inner wall of a compressor.

FIG. 5 is an enlarged diagrammatic view of the configuration of the end of a sliding vane type air compressor vane with the inner wall of an air compressor.

FIG. 6 is a typical shape of a compressor vane formed in a worn cup and plunger or piston/cup die.

FIG. 7 is a typical fiber ply pattern made in a worn cup/die type pultrusion die.

FIG. 8 is a diagrammatic view of a typical fiber pattern formed at the edge of a consolidation plate pultrusion die shown in a partial cross section of the pultrusion die of the present invention.

FIG. 9 is a side view of the pair of the die plates or consolidation plates in accordance with the present invention.

FIG. 9A is an end sectional view of improved die plates or consolidation plates as shown in FIG. 9 in the relationship in which they would be used in accordance with the present invention.

FIG. 9B is a cross sectional view of the improved die plates or consolidation plates at cross-section 9B in FIG. 9.

FIG. 10 is a diagrammatic view of the improved vane tip shape in an air compressor in accordance with the present invention illustrating the improve fiber arrangement at the tips of the vanes.

FIG. 11 is a side elevation of the consolidation plate and operational apparatus therefore with the plates in “full” open position.

FIG. 12 is a partial side elevation of the consolidation plate arrangement and operational apparatus therefore with the plates in closed position at the end of the consolidation cycle.

FIG. 13 is a partial side elevation of the consolidation plate arrangement and operational apparatus therefore with the plates in mid open position.

### DETAILED DESCRIPTION OF THE PREFERRED EMBODIMENTS

The following detailed description is of the best mode or modes of the invention presently contemplated. Such description is not intended to be understood in a limiting sense, but to be an example of the invention presented solely for illustration thereof and by reference to which in connection with the following description and the accompanying drawings one skilled in the art may be advised of the advantages and construction of the invention.

It is widely known in the art of making fiber reinforced plastic composites that the necessary fibers and a thermoplastic composition can be preheated to a temperature above the melting point of the plastic resin and immediately pulled through a shaped die to create the cross-section of the part to be produced whether such part be a finished part or a preliminary blank of some sort for later finishing. Since the fibers, if continuous, can be conveniently used to pull the blank through the die and, in fact, if continuous, would be difficult to extrude through the die, the fibers if longitudinally oriented are commonly made use of to draw the plastic composite through the die drawing melted plastic resin intermingled with the fibers along with them in an operation commonly referred to as “pultrusion”.

Pultrusion is commonly used both to form prepreg, or preimpregnated resin composite, destined to be combined with other prepregs, often as superimposed composite sheets or ribbons of separate sheets or ribbons of prepreg, or in many cases to form a final elongated product from many layers of prepreg shaped in a pultrusion die. In such cases, the final dimensions of the preliminary prepreg do not normally have to be as accurate or critical and the power requirements for pulling the pultruded product through the pultrusion process are not as great so the pultrusion process of the present invention will not have such heightened advantages as for making a final product as explained below. However, it will be understood that while described below for a particular critically shaped and formed product that the advantages of the invention will be found useful in making almost any pultrusion product. In general prepreg material which may be made in the same facility as a final product such as the critically shaped vanes of sliding blade pneumatic or vacuum pumps particularly dealt with in the present invention, more typically commercially available prepreg will have been made at another facility and supplied as a blank commercial product or prepreg for making other products.

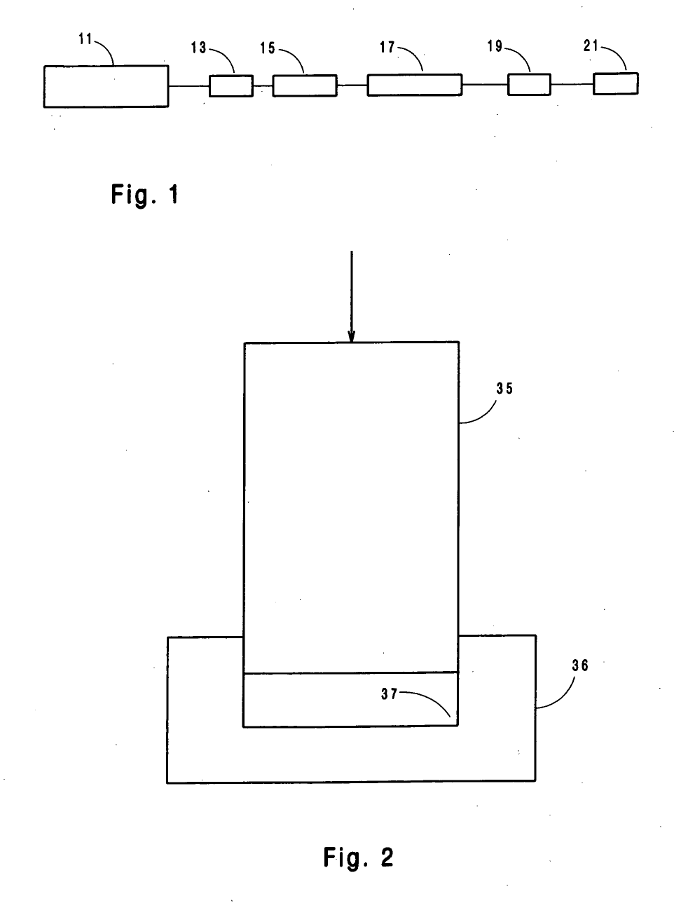

The cross-section of the die provides the cross-section of an item being subjected to pultrusion formation. The key functional parts of a pultrusion operation are shown in FIG. 1 where 11 indicates a so-called creel rack where it will be understood, reels of flexible prepreg not shown are unreeled or otherwise paid off, and then passed through a heater arrangement 13 until the plastic resin is above its melting point and then passed through a consolidator 15 which in the usual case will be either a cup and plunger die or occasionally a roller die or some other suitable die to determine the outer shape of the elongated material being made. Normally then the elongated now solid composite will be heat treated at 17 to establish its properties and will then pass to a puller 19 of some sort which may be multiple rollers, powered belts or other means for placing drawing tension on the elongated material. Thus the prepregs or already prepared fiber resin blanks or strands will be drawn from the creel rack 11, heated in the heater 13 and consolidated together with other prepregs in the consolidator 15, which in the case of the present invention will comprise two reciprocating cooled plates as further explained below, which will automatically be compressed about the prepregs being consolidated together in accordance with the present invention and reciprocated forward and backward in a continuous sequence to mold the final cross section. The product is heat treated if required to establish its desired properties and the individual products will be cut to length at 21 by a suitable cut off saw.

The reciprocating aspect of the consolidating dies is having them open and close. The dies only move reactive to the pulling force forward and backward as a function of how forcefully they are contacting the strip, i.e. when the die plates are fully open and the front end, i.e. the high force end of the dies, is not in contact with the strip the dies are fully forward toward the heater for the material. As the dies close, they come in contact with the strip. Initially, they slide on the strip until the force, or the die to strip friction coef., exceeds the initial die return spring force. After that the dies move with the strip until the dies are fully closed. When the dies start to open, the die to strip force relaxes and when the return spring exceeds the die drag force, the dies rapidly return to their fully forward position. In other words, the forward/backward die motion is a result of the opening and closing action of such die. This will be further explained below.

Constant cross-section parts can be made from fiber reinforced plastics using the pultrusion process. Compressor and pump vanes are examples. These vanes look like long strips that have a rectangular cross-section. The vanes have been traditionally made from composites consisting of various fiber reinforced plastic resins. The fibers produce the excellent mechanical properties of the composite, while the resin serves as the binder (glue) that holds the fibers in place. Fibers are oriented as required to produce the desired mechanical properties of the end product.

Compressor and pump vanes must be strong in the lateral direction since they function as a uniformly loaded cantilever beam extending out of the pump rotor slot while exposed to differential pressures (the loading). Consequentially, the normal vane design practice is to orient sufficient fiber across the width of the vane to withstand the bending loads. Additionally, some fiber must also be oriented in the length direction of the vane to give the part enough strength to be pulled through the fabrication process. Therefore, the mass or prepreg used in the process has alternating layers of prepreg with 0 and 90 degree fiber orientations. The fiber layers and orientations are normally visible to the naked eye when a cross-section of the pultruded part is polished and closely examined.

An end or cross sectional view of a rotary sliding vane compressor 23 is shown in FIG. 3. A slotted central rotor is positioned eccentrically within a circular cylindrical housing 25. Vanes 25 fit loosely in the rotor slots 27 and as the rotor 29 turns, the vanes are thrown by centrifugal force against the cylinder wall 31 to effectively form gas pockets between adjacent vanes 25, the cylinder wall 31, and the outer surface of rotor 31. The pocket volume is greatest when the mid point between adjacent vanes are at the 12 o'clock position. At that point, the trailing vane passes the end of the intake port trapping the gas in the pocket. As the pocket rotates towards the discharge port, the pocket volume decreases causing the gas pressure to increase. When the pocket's leading vane crosses the discharge port, the trapped pressurized gas is pushed into the compressor's discharge port.

As the rotor 25 in FIG. 3 makes a complete revolution, the point at which such vane contacts the cylinder wall moves back and forth across the tip. Starting with the vane at the 6 o'clock position, the vane touches the cylinder at the center of the vane tip. As the vane moves toward the 9 o'clock position, the contact point moves towards the back edge (corner) of the vane. At the 9 o'clock position, it is at the rear edge of the vane tip. From the 9 o'clock position to the 12 o'clock, the contact point moves back to the center of the vane tip. As the vane moves from 12 o'clock to 3 o'clock, the contact point moves to the leading edge of the tip. At 3 o'clock, the contact occurs at the leading edge. From 3 o'clock to 6 o'clock, the contact moves from the leading edge back to the center.

Considering a vane mounted in the rotor that has it's entire tip as a flat surface perpendicular to the side faces the vane with no chamfering of the tip corners, at the 9 o'clock position such vane will have line contact with the cylindrical walls. All the forces acting on the vane tip would be applied on the back corner as indicated by 33 in FIG. 3. The drag friction force from the cylinder wall “tries” to peal off the outermost laminate layer from the rear surface of the vane. The chances of the blade failing are therefore fairly high.

The above described failure mode is typically referred to as vane delamination. It occurs most frequently on new vanes that are installed in a compressor that has experienced a wash-board wear pattern in the cylinder. The wash-board cylinder wear typically occurs in the cylinder's inlet port area. Wash-boarding subjects the vane tip to severe impact loading as the vane skips across these “speed bumps” on the cylinder wall. This is where the new vane is most vulnerable.

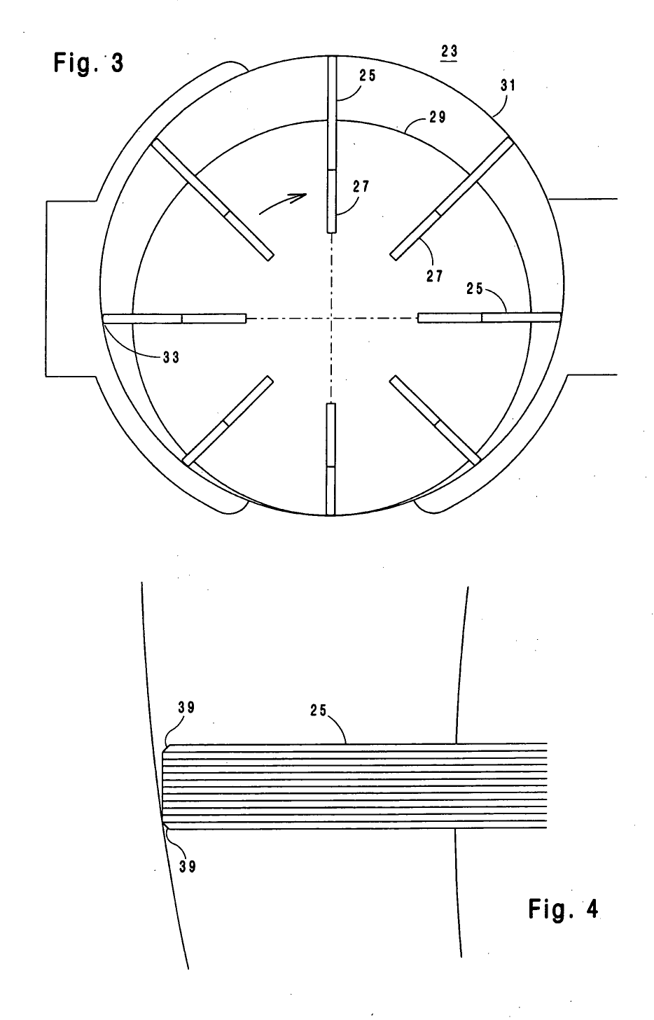

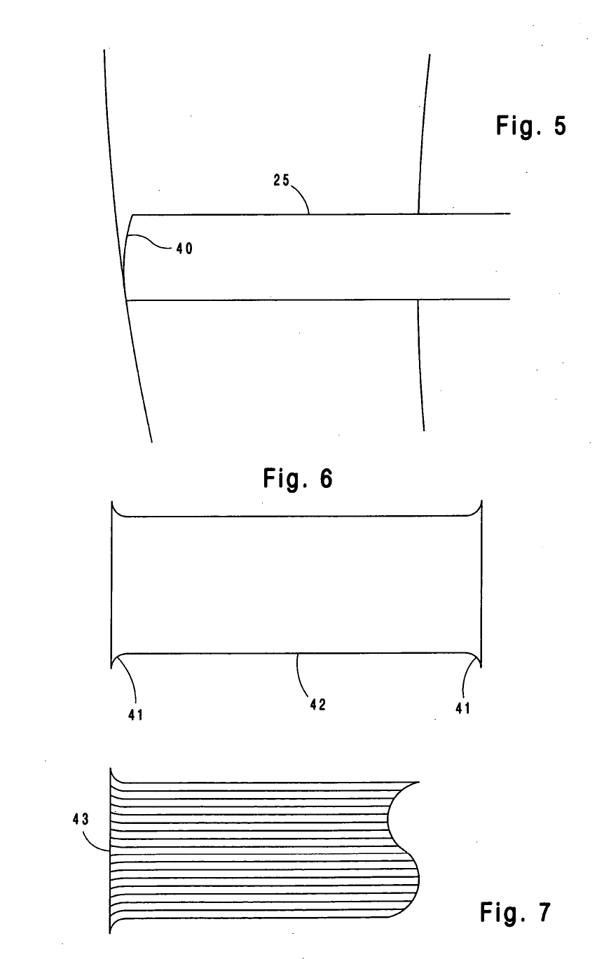

Customarily, new vanes are chamfered on all the vane tip corners to improve their chances of survival particularly during a break-in period. Chamfering the corners of the vane tips moves the contact point away from the rear edge, placing more composite plies in service to withstand the delaminating forces. See area 39 in FIG. 4. The chamfering step is usually a manual process that is subject to human error. If the chamfer isn't large enough or the inner-ply strength isn't high enough, delamination will occur. After the vanes are broken-in, the tip becomes rounded like that shown in FIG. 5 at 40. After the vane tips are “broken-in” in the contact area, especially in the inlet port area, accumulated wear is usually high enough (reducing contact pressure) to withstand delamination at least for a substantial period.

When vanes or other products are made by the pultrusion process, the part shape is established in the consolidator dies. Using a conventional piston cup die configuration, as shown in FIG. 2, as such consolidation die, the piston 35 is forced into the cup 36 against the composite material passing through the die. The squeezing action against the hot soft composite between the piston end and the bottom of the cup forces the composite laterally so it firmly contacts the side walls as well (surface 37 in FIG. 2). Most of the wear in a cup and piston die occurs in this area.

The amount of material entering the die controls the thickness of the part with a piston cup die. If too much enters the die, the part is too thick and if too little enters, it is too thin.

Prepreg in sheet form is typically used to make flat parts like vanes. Layers with alternating orientations (0-90 degrees) are used as feed stock to obtain the required properties in each direction. These alternating layers of prepreg are heated until they are soft and fusible. Then these plies are squeezed together as they are pulled through the die opening. Since the thickness of the part is determined solely by how much prepreg is pulled through the die opening, adding or subtracting a single sheet of prepreg has a significant affect upon the vane thickness.

Compressor vanes must be held to a close thickness tolerance to properly fit in the rotor slots. That tolerance may often be typically less than one layer of prepreg. Therefore, with a piston cup die design it may be necessary to pultrude the vane to a thickness greater than the finished part thickness and later machine it to the desired thickness. This practice, however, wastes expensive material and increases productions costs.

A piston cup die configuration also causes a dimensional tolerance issue when it is used to produce flat rectangular parts like compressor vanes. Such problem is created by the non-uniform cooling that naturally results in the dies. The dies must be cooled on all sides so the resin doesn't adhere to them while the molten resin and fiber are drawn through the dies. When the hot composite contacts the cool die surface, it will drop below its melting point. First on the surface skin and the farther and farther into the core. The problem with the piston cup die configuration is that it quickly causes the resin to solidify in the vane corners and edges (vane tips) while the mid section of the vane, especially the core remains soft and molten. This differential cooling causes the flat part to be thicker at the edges and thinner in the mid section.

Such non-uniform cooling also causes a compounding problem with respect to die wear. The transition from semi-fluid to solid of the resins starts at the edges (vane tips). The edges of the resin passing through the die are solid while the mid section is still soft in its core. Thus, a large part of the piston force is transmitted through the solidified edges (tips) of the vane causing high die contact stresses. These localize stresses create excessive wear on the piston and the cup near the sidewalls of the cup. As such wear progresses the intended flat part tends to become even more non uniform—thicker at the edges and thinner in the mid section. FIG. 6 illustrates a typical cross-section of a rectangular part formed in a piston cup die. Showing typical spreading of side edges at the ends caused by die wear plus non-uniform cooling. This problem further makes final machining to proper thickness a requirement to achieve a flat part that is within thickness tolerance. The part tends to be thicker at the ends 41 than in the center 42 in absolute terms.

The worn configuration of the die also has an impact on how the lateral prepreg fibers may be oriented within the final part, especially at the edges of the vane. FIG. 7 illustrates how these fibers tend to be oriented at the vane tip by worn piston cup dies. A splayed out form tends to be assumed as shown at end 43.

Another significant drawback of the piston cup die is the large force required to pull a part through it. Such part is literally being pulled through an orifice like opening. This force also adds to overall die wear.

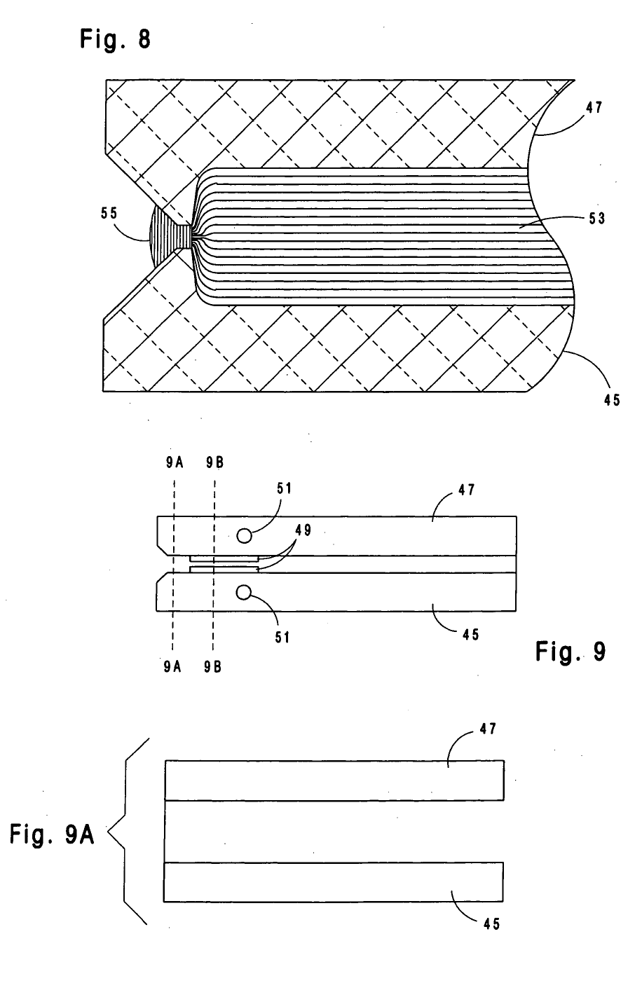

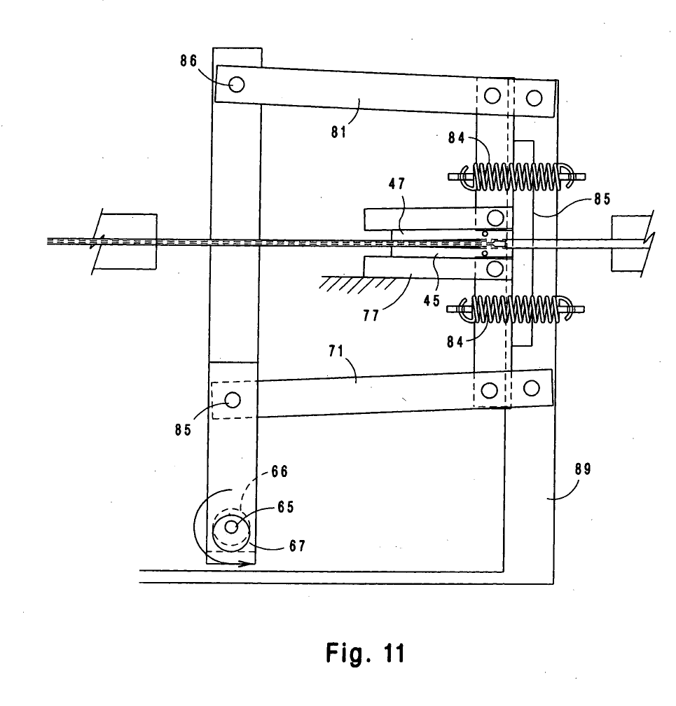

The present invention consists of a consolidator 15 that contains two matching dies 45 and 47 referred to as consolidation plates 45 and 47 that cyclically open and close relative to each other in such a way that they never touch each other at any time. See FIG. 11. The gap or distance between the consolidator plates or dies remains the same at all times at the entrance between such plates since such portion of the plates always remain in contact with the part being formed. However, the rear portion of the consolidation plates open and close or move toward and away from the work piece in a regular cyclic motion. As they close the plates come in contact with the hot formable composite being drawn along the line in a way that any excess feed material is squeezed out the sides and becomes flashing to be trimmed off later. See FIG. 8. When the dies close, they contact with the hot composite. While making contact the die plates are free to move with the composite. Therefore, the dies do not slide over the composite but largely rather ride on the composite for a short time and distance while pressing on the surface. When the dies start to open the die force exerted on the composite diminishes. When it gets very low, the die plates are returned to their neutral resting place by spring tension or other continuous tension. The force to pull the composite through the consolidator dies is never greater than the spring force that returns the die plates to their neutral resting place or condition. The resulting action on the composites is quite similar to a forging operation.

The dies or consolidation plates are water cooled to keep them from becoming so hot that resin from the prepreg adheres to them and leaves blemishes on the finished part. The water-cooled dies cause the composite being squeezed between them to solidify across the width of the part being formed. At the inlet end of the die, the excess composite material is squeezed out the side gaps of the die. The length of this edge forming section is as short as possible to develop its shape without affecting significant cooling. FIG. 8 shows the cross-section of the die plates at the tip end. Thereafter the reciprocation of the plates forces additional material out the sides and causes a flow in the partially molten or plasticized resin which causes transverse fibers in the stack of prepregs to assume a configuration as shown in FIG. 8 which configurations persist in the final product reinforcing the edges and making the product very resistant to later delamination. In FIG. 8 the lower die plate 45 and upper plate 47 are shown partially surrounding a molded vane edge or product edge 51 in which fibers 53 are shown molded between the two plates toward a side opening between the plates and leading into a deposit of excess material expelled from between the plates as a small flashing 55. It can be seen how the fibers tend to conform to the die surface.

Relieving the excess material out of the side openings between the consolidation plates allows the part to be pultruded to finished dimensions without subsequent machining to thickness. The length of the die entrance side walls must be short enough to not over cool the side edges (vane tips) so much that they can not be subsequently brought to the same thickness as the mid section of the part. The trailing end of the die causes the part to be uniformly cooled across its width so the thickness variation from the edges to the mid section are negligible. See FIG. 9 for a typical side view of a die plate or consolidation plate combination of the invention. The die plates or consolidation plates 45 and 47 are pivoted from the leading end at which the fiber resin composite blank formed of several prepreg layers of fiber-resin composite, usually about 11 to 13 or so thin prepreg composites enter between such consolidation plates 45 and 47.

FIG. 9 is a side view of a pair of consolidation plates 45 and 47 opposed to each other in operating position. The entrance end for a flat stack of thin prepreg material is on the left side and the major movement of the plates is toward the right. The opening between the plates is on the left, which because of the mounting of the consolidation plates retains them the same distance apart and sets the essential thickness of the vane. The right side of the plates 47 and 45, however, reciprocate up and down slightly and serves to compact the prepreg material by patting and compressing it as the prepreg material passes through the operation.

FIG. 9A is a transverse sectional view through the consolidation plates shown in FIG. 9 along section line 9A showing that there is no side constriction at this point. It will be noted that no side section is provided on the plates at this point and merely the thickness of the product is determined, the sides being left free to accommodate to the transverse thickness of the product. FIG. 9B, on the other hand, is a cross-section of the consolidation plates 45 and 47 through section 9B and shows a cross-section of the trim or side forming sections 49 on the two plates 45 and 47 such trim sections extending toward each other, but no touching each other. Such trim sections establish the width of the product and the distance between such die forming sections 49 and the planar portions of the plate determine the basic pattern of curving of transverse fibers at the sides of the product plus the thickness of the thin flashing formed on the sides of the pultruded product which is ultimately severed from the product as a final step. Orifices 51 in the consolidation plates provide inlets for cooling water. Cooling of the consolidation plates quickly solidifies a thin skin upon the hot plastic resin and prevents it from sticking or adhering to the consolidation plates. FIGS. 9A and 9B are somewhat enlarged scale from FIG. 9 in order to better show the presently preferred shape of the trimming sections 49 which, however, could take other similar forms. It has been found that for best results, the trimming sections should be set back somewhat from the anterior or front end of the consolidation plates 45 and 49 so that the thickness of the product is established before the width is established. A more uniform product is thereby attained. As indicated, the distance of the plates because of their mounting does not vary at their front ends, but the rear ends separate sufficiently periodically so the plates are no longer touching the product. When the entire surface of the plates contacts the product surface pressing upon it and consolidating there is sufficient friction between the product, or incipient vane, so that the plates are carried along with the product or vane. However, when the rear of the plates separates and only a very short section of the consolidation plates at the front of the plate is touching the product there is no longer sufficient friction to draw the plates along with the product and the entire plate assembly is retracted toward the beginning of the pultrusion line by a suitable tension means. Thereafter, the plates are closed again upon the pultruded product and are carried again down the line with the product pressing and consolidating the product. As a result, the product is thoroughly consolidated, but is not forced through or between the plates and such plates do not slide upon the product to any significant extent at all. The plate operation mechanism is adjusted so that every section of such product is subjected to sufficient contacts with a closing of the plates to thoroughly consolidate the product and the pultrusion speed is adjusted so the consolidation plate mechanism is operated at an effective rate for thorough consolidation.

Die plates or consolidation plates of this design are long lasting because of their non-sliding operating principal. Each die plate can be designed to contain key product features. For example, fillets and chamfers can be molded into the part as it is pultruded rather than adding them later. The edge walls do not have to be parallel as they must be in the standard piston/cup dies. For example, the end corner wall can flare out until they meet the opening for the flashing. The gap where the flashing is forced out is the only common reference between the two die plates. The width of the dies must, however, be designed to account for thermal shrinkage when the part cools during and after it leaves the dies.

If the part has a close tolerance width dimension, the flashing can be designed to start exactly where the edge of the part should be. Since this flashing is thin relative to the thickness of the vane it is easily removed by sawing rather than by milling as would be required if the entire thickness needed to be machined. With piston/cup dies the entire edge thickness must usually be milled to attain the desired dimensions.

For compressor vanes the die configuration of the invention has distinct advantages over the piston/cup die. The forging-like action of the die plates cause an unusual alignment of the lateral fiber ends (those that run across the width of the vane) of the outer surface prepreg plies that run perpendicular to the vane edges. The dies cause these fiber layers to mold around the corners at vane tips. This feature has a very beneficial affect on the performance to the vanes—especially when they are brand new and installed in a compressor that has sustained some cylinder wear. This redirection of the fibers strengthens the vane tips and makes them less susceptible to delaminating early in their service life. In conventional piston cup dies the fiber plies do not wrap around the corners and instead run perpendicularly into the edge providing no extra strength and resistance to delamination.

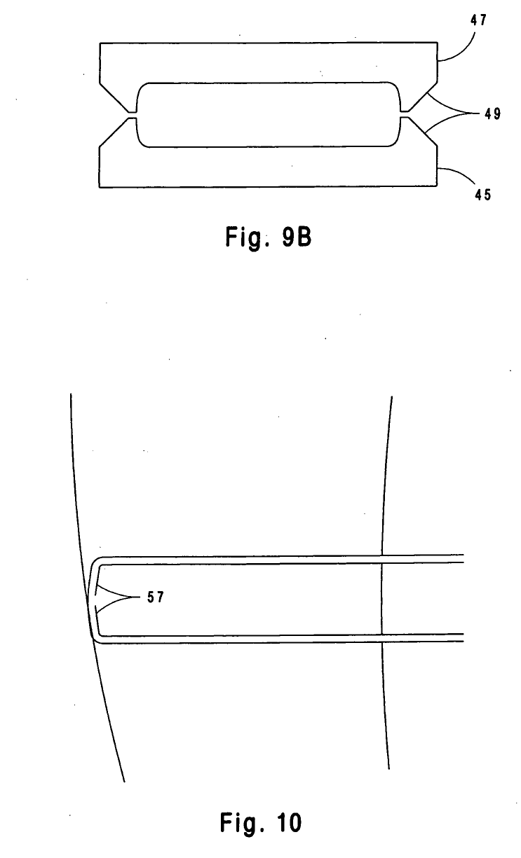

FIG. 10 illustrates two ways how this invention contributes to solving new vane startup delamination failure. The vane tips as shown in FIG. 3 are not perpendicular to the vane center line. These surfaces are designed to be parallel to the cylinder wall when the vanes are in the 3 and 9 o'clock positions. A small rounding fillet is used at the tips that is tangent to the back and front faces of the vane and the angled tip surfaces as shown in FIG. 4. The angled tip surfaces greatly reduce the vane tip contact stresses on new vanes before they are broken-in. In addition to this geometric feature, the die shape at the edges (tips) causes fibers that run across the vane width to wrap around the corners as shown in FIG. 10 at 57 in a way that the corners are strengthened by fiber reinforcement (as discussed above). With this design inter ply bond strength of the resin no longer is a significant design factor.

FIGS. 8, 9A and 9B show in the case of FIG. 9 a side elevation of a die plate or reciprocating consolidation plate and FIG. 8 is a partial cross-section of one side of two matching consolidation plates 45 and 47 in the process of molding a compressor vane between them showing how the ends of the transverse fibers are molded at the edges as excess resin is forced from between the plates. The initial section of the plates shown in FIG. 9A establish the thickness of the product and the second section shown in FIG. 9B shows the amount of thin flashing 55 which is expelled from between the plates. Thereafter the rear section of the plates continuously reciprocates into overlapping contact with the product until substantially completely hardened. A water cooling inlet 51 provides cooling water to the consolidator plates or dies to initially form a solid outer skin on the product and then ultimately to cool and solidify the entire product. As in FIGS. 8, 9A and 9B as the prepreg enters the die or gap between the consolidator plates the cross-section of the products is formed in a two step process. As the soft plastic material enters the die it is subjected to a cyclic squeezing motion by the die or consolidation plates the forward ends of which form a constant closed gap between the two plates which sets the part thickness. Immediately after the thickness is established the still soft edge forming section is reached where excess material is forced out the side gap between the plates and the shape of the edges of the product is formed. The water cooling passage 51 is located near the entrance to the dies or plates. The cooling provided keeps the dies or plates at a sufficiently low temperature to prevent the molten resin from adhering to the plates and causing general cooling.

As explained, the plates are carried by the moving prepreg along with such prepreg until the rear of the plates start to raise off the prepreg at which point the two plates are pulled by springs not shown (but see FIGS. 11, 12 and 13), toward the front of the line where they again clamp about the prepreg by a mechanical action hereafter described. This reclamps the plates against the prepreg smoothing out the surface and again carrying the plates along with the prepreg down the line until the plates 45 and 47 are again released and pulled by springs back to their starting position. Meanwhile the pultrusion line continues operating.

A more detailed description and explanation of the mechanical operation and construction of the reciprocating consolidation plates of the invention follows below:

FIGS. 11, 12 and 13 illustrate the presently preferred mechanism and process for opening and closing the dies on the heated soft composite product thus forming it into its desired shape while it is still soft and formable.

FIG. 11 shows the die plates or consolidation plates 45 and 47 in the fully opened position. The die plates are driven by a drive shaft 65 powered by a motor not shown.

The drive shaft 65 includes 2 pairs of eccentric journal bearings 66 and 67 and two support bearings, not shown, that hold the drive shaft to the consolidator support frame. One pair of journals drive connecting rods that move a lower rocker arms 71 and lower die 45 mounted upon a die support plate 77. The other journals drive the connecting rods that move the upper rocker arms 81 and upper die 47 and die support 77. As the drive shaft rotates the mechanism causes the upper and lower die plates to open and close in a coordinated manor. Both die plates open and close at the same rate and the same amount.

While the dies 45 and 47 are opening and closing the strip of finished product is being pulled by a suitable pulling device, not shown, at a steady speed through the prepreg heater platens, not shown, and then the consolidator plates and then the annealer also not shown. Each time the dies go through a complete cycle the strip of composite advances a small amount. The step size movement of the consolidator dies is inversely related to the consolidator cycling rate and directly related to the pulling speed.

When the dies are in their fully open position they no longer touch the incoming molten mass of heated composite. The die return springs 84 hold the compression links against the compression link guide or stop 85. This is the most forward position of the dies.

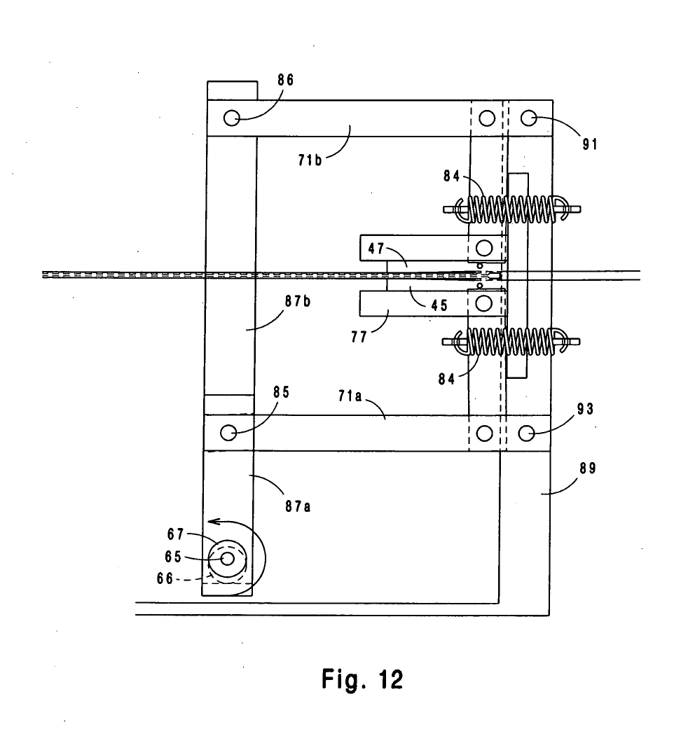

As the dies close they contact the molten composite. As the compression force increases during the clamping cycle, the friction between the die plate and the moving composite strip exceeds the die return spring force thus causing the die to move with the material being consolidated. FIG. 12 shows the position of the die plates at the end of the consolidation step when the dies are fully closed. The maximum drag force on the dies is limited to the spring return force instead of a substantially higher drag force if the dies were not free to move with the consolidated strip. Very little sliding and wear occurs between the die and the consolidated strip because of the relatively free movement of the dies or consolidator plates.

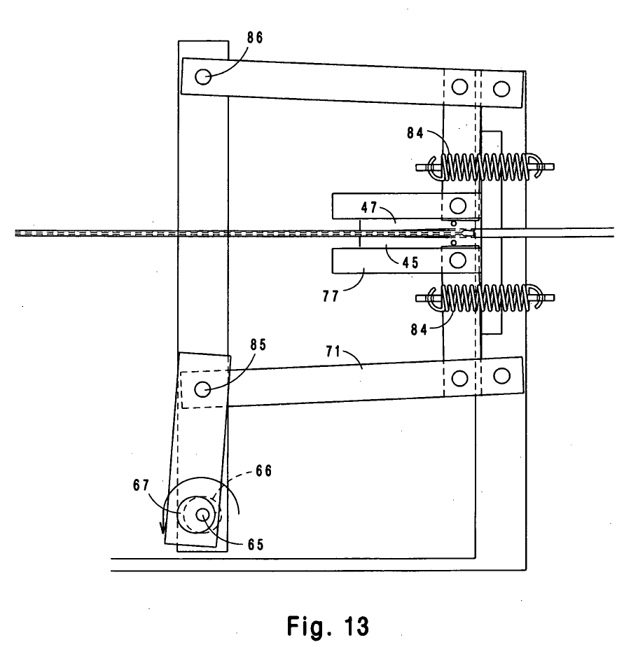

After the dies have fully closed forming the vane, they start to open. FIG. 13 shows the dies in the mid open position. As the die plates move away from the consolidated strip the drag force that the consolidates strip applied to the dies quickly decreases. When the drag force is less than the die return spring force the dies move forward—opposite the consolidated strip direction of movement. When the dies fully disengage from the consolidated strip the springs pull the dies back to the original starting point shown in FIG. 11.

The dies are designed such that they form the vanes in a sequential process. The entrance of the die establishes the vane thickness. The unconsolidated mass of composites entering the dies is thicker than the closed gap between the dies. The minimum gap between the dies establishes the vane thickness. Immediately after the thickness is established the edges are formed. All excess material is pushed out the sides of the dies in the form of flashing. This flashing is later removed from the strip.

Small adjustments in the vane thickness can be made without shutting down the pultrusion process.

The rocker arms pivot around connector pins 85 and 86 that are attached to the rocker connecting rods 87A and 87B and support mast 89 pivot pins 91 and 93 connect the rocker arms 71A and 71B to support mast 89. The lower pivot pin is held at a fixed location on the support mast. The upper pin although it is also attached to the support mast, can be raised or lowered for adjustment of the process. By raising the upper pin, the gap between the die plates is increased. Lowering the pin will reduce the closed die gap.

The die plates are, as indicated earlier, water cooled. Cooling prevents the plates from becoming so hot that the dies stick to the composite strip. The cooling also causes the composite to solidify into a hard straight strip before it leaves the consolidation dies and enters the annealer.

As explained, the consolidation plates of the invention, when fully applied to the product being molded move with the pultrusion product as they are exerted against the product to mold such product for a limited travel path and then open as they are returned to position from which they can then again travel with the product a short distance down the line in a series of progressions. Unlike a normal cup and plunger die, very little energy is expended in pulling the product through the consolidation plate stage. In addition, while the basic cross-sectional dimensions of the product are established by the initial opening between the consolidation plates at the entrance to such plates, the side of such opening remains essentially open for the outflow of excess plastic resin into the final thin flashing on the sides of the molded product and does not build up in front of the die or require considerable lateral force to be compacted uniformly among or between the fibers. Instead, the continuous reciprocating, overlapping patting action of the consolidation plates serves to consolidate the semi-molten resin thoroughly between and among the fibers forming a dense fiber reinforced resin product compacted by the reciprocating movement of the consolidation plates. As a direct result, the power used to draw the product down the line is considerably reduced by a major percentage from what would be the case when using a cup and plunger die. A simple opposed double roll powered capstan has proved quite adequate, although any similar capstan such as multi-roll capstans, belted capstans and the like could also be used, although because of the stiffness of the solidifying product a wrap-around capstan would not be usable.

While the basic cross-section of the piece or product is established by the opening at the forward end of the consolidation plates, this opening even here is partially open at the sides so that heated plastic is expelled in a thin side flashing which continues to grow as the plastic is smoothed down and consolidated into a uniform ribbon by the progressive reciprocation of the consolidation plates against the product while the water cooling of the plates forms and maintains a solidified skin upon the product and gradually cools the entire cross-section. As a result, not only does the product not meet as much resistance passing through the reciprocating consolidation plates of the invention, but the plates themselves are virtually wear free unlike the wear encountered in the usual plunger and cup die as explained above. This lack of wear results no only in less changing of dies, but also eliminates the extra grinding or sanding of the surface of the molded product usually necessary to meet specifications, particularly with respect to the out of shape product, usually met at the bottom of a cup and plunger die as previously explained.

As a result of the above factors, that is a saving in power requirements, plus less finishing being necessary, the use of the consolidation plates of the invention provides a better fiber reinforced product at a very substantial saving over the usual manufacture of similar products or other pultrusion apparatuses.

A good part of the advantage gained by the consolidation plates of the invention in less wear of the die is due to the lower pulling or capstan force required by the use of the consolidation plates of the invention. Less force exerted upon the die plates results in less wear on such die plates or consolidation plates, than is the case with cup and plunger dies, yet between the fibers as well as the fibers and the plastic resin the compacting efficiency is high. A comparable high consolidation is reached with a piston/cup die, however, this results also in high die wear within the cup of the die. The consolidation plates of the invention have been found, however, to experience virtually no wear, and very seldom, if ever require replacement or repair.

In the making of vanes for pumps and the like, furthermore, the edges of such vanes can be shaped or configured to optimally match the pump cylinder walls without requiring frequent additional edge shaping machinery, a further advantage of the present consolidation plate invention, which cannot be attained by use of a cup and plunger or piston die.

The forgoing advantages have been found to be inherent in the use of the reciprocating consolidation dies of the invention independent of the advantage of the attainment of better distribution of the ends of transverse reinforcing fibers in the product thereby improving side durability and virtually eliminating delamination of the product at the sides as previously explained. For example, there would be a considerable advantage and saving in making a product such as a pump vane even if such product did not have transverse reinforcing fibers or even if any such fibers did not extend to the sides of the vane so they could be molded into a curved conformation. In such case, the additional efficiency and savings in the pultrusion process are still experienced as explained above.

A still further advantage of the consolidation plate type pultrusion die of the present invention is that as mentioned above, it is often the case that a product such as the vanes or blades of a pneumatic or hydraulic pump as explained in this application may have a critical thickness which when formed by compaction of prepreg material in a pultrusion die will not be essentially equal to the thickness of the addition or subtraction of one layer of prepreg from a stack of the commercially available thickness of prepregs. In such case, a stack of prepregs oversize will have to be consolidated in a die often to an oversize thickness and have to be machined or sanded down to dimension not only wasting prepreg material, but also wasting power in reducing to close to required dimensions and then frequently sanding or machining to final size. With the consolidation plate pultruder die of the present invention, however, a critical size dimension may be attained easily regardless of the thickness of prepregs available.

It will also be evident that the consolidation plate pultrusion invention of the present invention would be useful in making other products in addition to compressor pump vanes where it may be an advantage not only to reinforce the sides with the curved transverse fibers running into such sides, but also to do so with fewer operations and also with the expenditure of less power. In addition, where the ends of a product may be the important portion of such product, which should be reinforced against failures or delamination, it will be possible to pultrude a wide flat strip with long transverse fibers extending to the sides. Such preliminary prepregs or other preliminary blanks will be made usually, as explained previously, by interspersing a layer of separately made prepreg material with longitudinal, or oriented fibers and cut or severed into short lengths just as long as the main strip is wide and interspersing such short lengths into the middle of a portion of a pair of previous prepregs with longitudinal fibers. After being subjected to a pultrusion operation in accordance with the present invention, such composite product will have curved reinforcing fibers in the sides just as the above described prepreg formed product does and if the product is now severed transversely, preferably at the dividing point or line between individual transversely inserted sections, the final product will be found to have curved reinforcing fibers at the ends of the product instead of along the sides as in the previously described product. Such a product might be important, for example, where the blade of a turbine extends from a hub longitudinally rather than laterally as the blades of many aircraft turbines, for example, are mounted, although fiber reinforced thermoplastic vanes are, of course, unlikely to be used in an aircraft turbine where heat resistance is a prime consideration.

While the present invention has been described at some length and with some particularity with respect to several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention.

I claim:

1. A fiber reinforced plastic resin product having delamination resistant edges comprising:
(a) a substantially flat product made by a pultrusion process including reciprocating consolidation plates,
(b) such flat product having longitudinal and transverse reinforcing fibers,
(c) wherein at least some of the transverse fibers are curved at their ends along the edge of said product as a result of excess resin being forced from between the reciprocating consolidator plates during shaping into a flashing which is later removed.

2. A fiber reinforced plastic resin product in accordance with claim 1 wherein the product is longer than wide and it is the lateral edges that are reinforced by curved fibers.

3. A fiber reinforced plastic resin product in accordance with claim 2 wherein the product is a vane for a rotary vane fluid mediums movement apparatus having a need for delamination resistant lateral edges.

4. A fiber reinforced plastic resin product in accordance with claim 3 wherein the rotary vane fluid medium movement apparatus is a rotary vane pumping apparatus.

5. A fiber reinforced plastic product in accordance with claim 1 wherein the product is longer then wide and it is the transverse longitudinal dimension edges that are reinforced by curved fibers.

6. A fiber reinforced plastic product in accordance with claim 1 requiring no finishing steps subsequent to pultruding other than removal of thin transverse flashing and severing to length to bring all dimensions into usable product tolerances.

7. A pultruder die design comprising:
(a) two coordinated reciprocating plates arranged to close in a coordinated reciprocating manner upon one or more longitudinally moving prepreg sheets drawn through a fabricating line,
(b) the entrance to said reciprocating plates being held at a set distance from each other at the leading end through which the one or more prepregs is drawn at elevated temperature when the die plates are closed,
(c) the remainder of the plates being arranged to be reciprocal toward and away from the prepregs in a regular pattern of opening and closing,
(d) the opening and closing plates being arranged to be closed about the one or more prepregs and travel along with the prepregs when closed, and
(e) being mechanically arranged to be returned to a starting point when opened.

8. A pultruder die design in accordance with claim 6 wherein the coordinated reciprocating plates are coordinated by a mechanical oscillation mechanism including tension means for returning the coordinated reciprocating plates to their starting point by tensioning action when the plates are opened.

9. A pultruder die design in accordance with claim 7 wherein there is sufficient clearance between the sides of the plates to allow excess plastic resin to be expelled from the sides into a thin flashing carrying with it transverse reinforcing fibers which are left in an at least somewhat curved end of configuration when resin is extruded from between the plates said curving end configuration of transverse reinforcing fibers serving to restrict the sides of a product from delamination.

10. A pultrusion die design in accordance with claim 8 in which the coordinated reciprocating coordinator plates are water-cooled.

11. A method of making a flattened product having an extended longitudinal dimension and a lesser transverse dimension from fiber reinforced thermoplastic resin comprising:
(a) passing at least one prepreg along a pultrusion line having a pultrusion die formed of two reciprocating conformation plates, said conformation plates having repeating open, closed and in between positions,
(b) maintaining the entrance to such reciprocating plates at a set distance from each other on their forward ends such distance in the closed position being designed to set the dimensions of the product,
(c) allowing excess resin from the sides of the reciprocating plates to be expelled to the sides into a thin removable flashing.

12. A method of making a flattened product having an extended longitudinal dimension in accordance with claim 10 wherein the consolidation plates are cooled during operation and the plates are closed over the prepreg and carried along with the product for a predetermined distance and then released whereupon the plates are returned to their starting point.

13. A method of making a flattened product having an extended longitudinal dimension in which the product is provided with repeated overlapping consolidation side compressions which serve to compress the product into accurate final dimensions with a thin side flashing easily removed as a final operation.

14. A method of making a flattened product having an extended longitudinal dimension in accordance with claim 13 wherein the pultrusion force is substantially decreased from the force required when using a plunger and cup type pultrusion die.

15. A method of making a flattened product having an extended longitudinal dimension in accordance with claim 12 wherein high consolidation forces are obtained within the plastic reinforced product by the use of reciprocating consolidation plates without high pultrusion pulling forces normally met with in a piston/cup type pultrusion.

16. A method of making a flattened product having an extended longitudinal dimension in accordance with claim 12 wherein as a result of the consolidation plates moving along with the product as it is being formed and compressing the product transversely from the sides, only very minimal wear is experienced by the consolidation plates such that very accurate product dimensions are repeatedly obtainable.

17. A method of making a flattened product having an extended longitudinal dimension in accordance with claim 12 wherein the product being made is provided with transverse reinforcing fibers and these are formed at the sides by plastic resin flowing from the sides of the plates into the thin flashing and assuming curved configurations which serve to reinforce the sides of the product and discourage delamination of the original prepreg layers of such product.

18. A method of making a flattened product having superior dimensional properties as the result of repeated overlapping side compression movements of side consolidation plates.

19. A method of making a flattened product having an extended longitudinal dimension in accordance with claim 12 wherein the consolidation plates are moved down the line in each of their reciprocations by being pressed against the product being shaped by movement of the plate mechanism and are returned to their starting point by spring means.

20. A method of making a flattened product having an extended longitudinal dimension in accordance with claim 12 wherein the force necessary to draw the product along the line is determined essentially by the force exerted by a return tension means arranged to return the consolidation plates to their starting position at the end of each compression cycle.
